(19) United States
(12) Patent Application Publication
(10) Pub. No.: US 2013/0283885 A1
(43) Pub. Date: Oct. 31, 2013

(54) IMPACT ASSEMBLY

(71) Applicant: Kun Ta LEE, New Taipei City, Taiwan (TW)

(72) Inventor: Kun Ta LEE, New Taipei City, Taiwan (TW)

(73) Assignee: Kun Ta LEE, New Taipei City (TW)

(21) Appl. No.: 13/530,877

(22) Filed: Jun. 22, 2012

(30) Foreign Application Priority Data
Apr. 27, 2012 (TW) 101207887

(51) Int. Cl. G01N 3/30

(52) U.S. Cl. 73/12.04; 73/12.01

(57) ABSTRACT

An impact assembly including an impact platform and at least two impact generating devices is provided. The at least two impact generating devices are disposed adjacent to each other in pair and detachably mounted to the impact platform. Each of the at least two impact generating devices has a housing and an impact generating unit. The housing is adapted to form a compartment where the impact generating unit is disposed. The impact generating units of the at least two impact generating devices provide at least two impact forces to the impact platform according to the at least two corresponding timings.

This application claims priority to Taiwan Patent Application No. 101207887 filed on Apr. 27, 2012.

### CROSS-REFERENCES TO RELATED APPLICATIONS

Not applicable.

### BACKGROUND OF THE INVENTION

1. Field of the Invention

The present invention provides an impact assembly, and more particularly, to an impact assembly which can provide a continuous and stable impact force to an impact platform or an object under testing.

2. Descriptions of the Related Art

Driven by the rapid development of electronic products, relevant product specifications and industry standards have become increasingly stringent over recent years. To adapt to consumer demands, electronic products have become more low-profile, lightweight, and compact, while still capable of multiple functions. To maintain the operational reliability of electronic products and improve the resistance to vibrations during the transportation process, a series of reliability tests must be carried out during the research & development (R&D) process and before delivery. One test that is commonly used in the art is the impact test.

As shown in FIG. 1, an impact testing device 1 is used in the conventional impact test. Specifically, an impact generating unit 14 (e.g., an air hammer or an electric hammer) is disposed under an impact platform 12, and then an object 16 under testing (e.g., an electronic product) is fixed to the impact platform 12 by a belt or a fixing band so that an impact test is carried out on the object 16 under testing. When the impact generating unit 14 is actuated to provide an impact force, the impact platform 12 is driven to apply the impact force to the object 16 under testing. Then, by means of a sensing device (not shown) disposed on the object 16 under testing, a waveform generated in the electronic product due to the impact is analyzed, and damages (if any) caused to the parts inside the electronic product are observed using an electron microscope. According to the test results, either the design of the parts or the circuit of the electronic product can be improved. In addition, the package protection during transportation can be enhanced.

However, carrying out such an impact test might lead to the following problems. First, because of the reaction force applied to the impact generating unit 14, a period of time (i.e., a delay time) is needed for the impact generating unit 14, after it has impacted the impact platform 12, to restore its original impacting status before it can provide an identical impact force to the platform again. That is, if a preset interval between two consecutive impacts is too short, then it will be difficult for the impact generating unit 14 to provide a stable impact force accurately or immediately and also, it will be difficult to obtain reliable testing data. Conversely, if the interval between two consecutive impacts is too long, then the testing period will be extended; and in this case, with the total number of impacts remaining unchanged, it will be difficult to shorten the testing time.

Accordingly, it is important to provide an impact assembly that can continuously generate a stable impact force so that an external force to precisely simulate the impact that may be experienced by the object under testing; in addition, the interval between the two consecutive impacts can be effectively shortened.

### SUMMARY OF THE INVENTION

An objective of the present invention is to provide an impact assembly that can apply a periodic and consistent impact force to an object under testing, which could precisely simulate the external forces that may possibly be experienced by the object in practical use. In addition, the overall testing time needed can be shortened via the arrangement of the impact assembly.

To achieve the aforesaid objective, the present invention provides an impact assembly, which comprises an impact platform and at least two impact generating devices. The at least two impact generating devices are disposed adjacent to each other in pair and detachably mounted to the impact platform. Furthermore, each of the at least two impact generating devices comprises a housing and an impact generating unit. The housing comprises a compartment formed therein where the impact generating unit is disposed. In practical operations, each of the at least two impact generating devices provides a reciprocating motion by means of the impact generating unit, and the impact generating units respectively provide at least two stable impact forces to the impact platform by sequentially providing the reciprocating motion according to the at least two corresponding timings.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a conventional impact testing device;

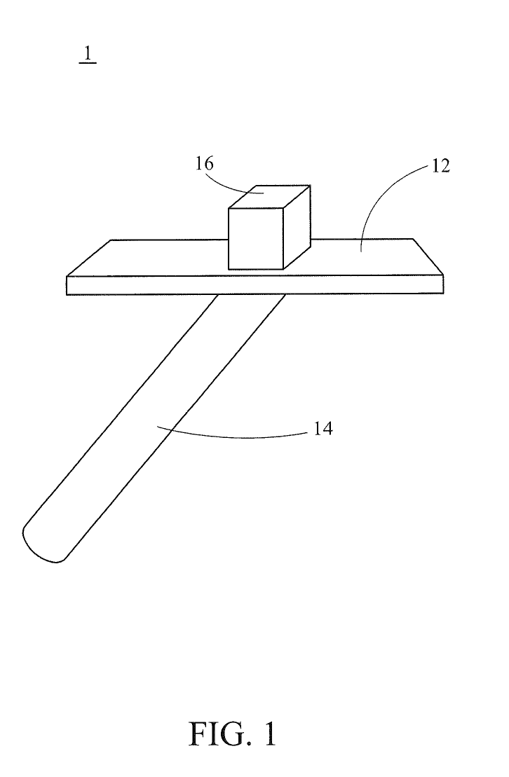

FIG. 2 is a schematic view illustrating the operations of a first embodiment of an impact assembly of the present invention according to a first timing;

FIG. 3 is a schematic view illustrating operations of the first embodiment of the impact assembly of the present invention according to a second timing;

FIG. 4 is a schematic view illustrating operations of a second embodiment of the impact assembly of the present invention according to the first timing;

FIG. 5 is a schematic view illustrating operations of the second embodiment of the impact assembly of the present invention according to the second timing; and

FIG. 6 is a schematic view illustrating operations of the impact assembly of the present invention according to the first timing and the second timing.

### DESCRIPTION OF THE PREFERRED EMBODIMENT

An impact assembly of the present invention comprises an impact platform and at least two impact generating devices. Each of the two impact generating devices comprises a housing and an impact generating unit. The impact generating units of the two impact generating devices can provide a reciprocating motion according to the corresponding timings respectively.

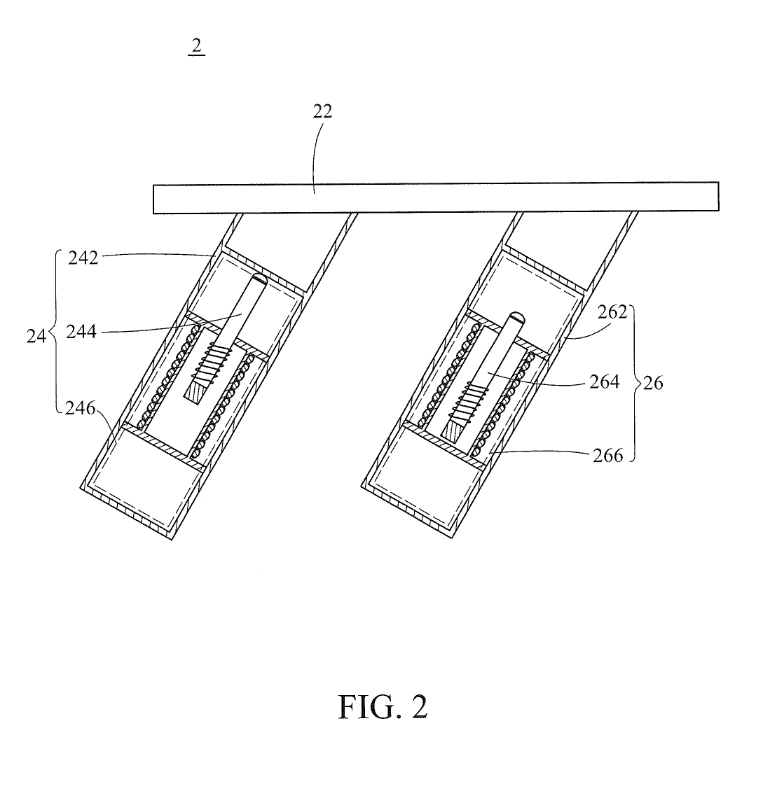

FIG. 2 shows a first embodiment of the impact assembly 2 of the present invention. As shown, the impact assembly 2 comprises an impact platform 22, a first impact generating device 24 and a second impact generating device 26. The first impact generating device 24 and the second impact generating device 26 are disposed adjacent to each other in pair and detachably mounted to the impact platform 22. Furthermore, the first impact generating device 24 has a first housing 242, a first impact generating unit 244 and a first compartment 246. The second impact generating device 26 has a second housing 262, a second impact generating unit 264 and a second compartment 266. The first compartment 246 of the first housing 242 and the second compartment 266 of the second housing 262 are adapted to accommodate the first impact generating unit 244 and the second impact generating unit 264 respectively, and the first impact generating unit 244 and the second impact generating unit 264 are adapted to provide a reciprocating motion according to a first timing T1 and a second timing T2 respectively.

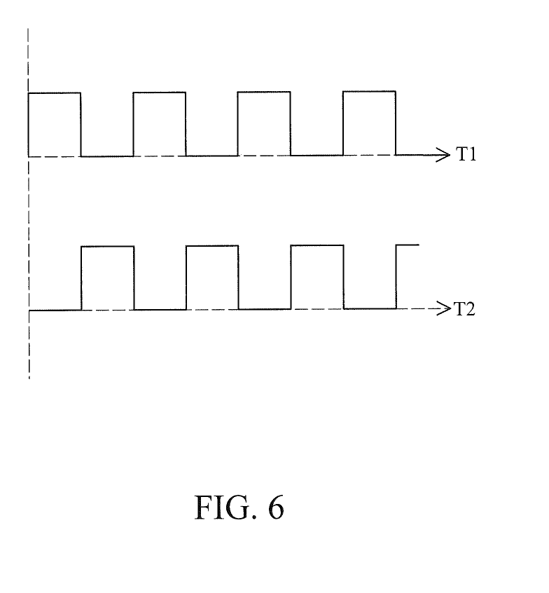

With reference to FIGS. 2 and 6 together, wherein FIG. 6 illustrates timing diagram, at the first interval, the first impact generating unit 244 provides a reciprocating motion according to the first timing T1 in the compartment 246 so that the first impact generating unit 244 of the first impact generating device 24 provides the first impact force to the impact platform 22, and stimulates the impact platform 22 to move upwards. Simultaneously, since there is no signal during the second timing T2, the second impact generating unit 264 does not stimulate the impact platform 22 to move upwards.

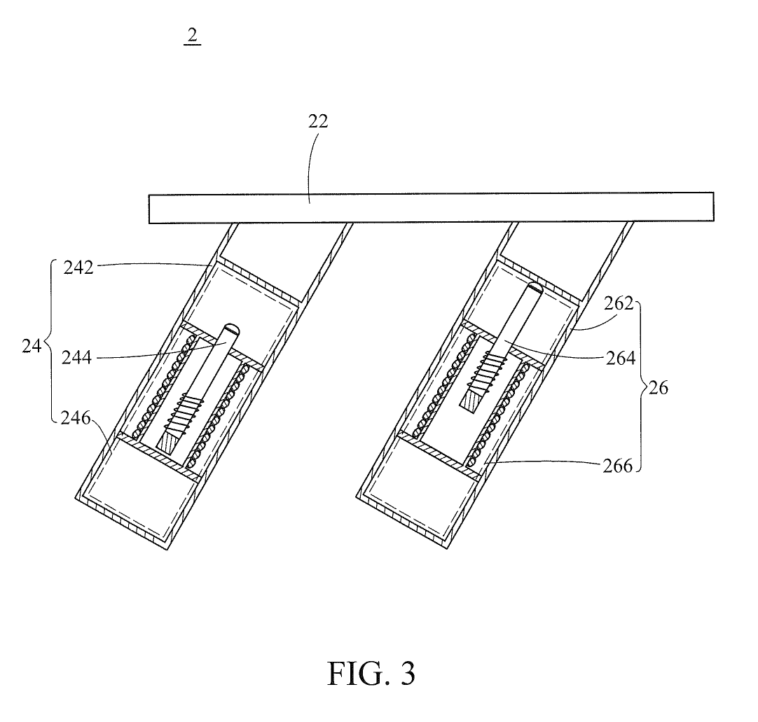

With reference to both FIGS. 3 and 6, at a second interval, which is after the impact platform 22 has been impacted by the first impact generating unit 244, the impact assembly returns to the initial position. The second impact generating unit 264 provides a reciprocating motion in the compartment 266 according to the second timing T2 so that the second impact generating unit 264 of the second impact generating device 26 provides a second impact force to the impact platform 22 and stimulates the impact platform 22 to move upwards. Simultaneously, since there is no signal during the first timing T1, the first impact generating unit 244 keeps still and does not stimulate the impact platform 22 to move upwards.

Therefore, according to the first timing T1 and the second timing T2, which are alternating and consecutive to each other, the first impact generating device 24 and the second impact generating device 26 provide the first impact force and the second impact force with the same direction and exact magnitude to the impact platform 22 respectively. Thus, a delay time that would be needed for the restoration of a single impact generating device in the conventional impact assembly can now be used by the other impact generating device, thereby, effectively shortening the interval between two consecutive impacts and shortening the time necessary for the overall test.

In this embodiment, the first impact generating device 24 and the second impact generating device 26 are each an electric impact generator, while the first impact generating unit 244 and the second impact generating unit 264 are each a micro vibration motor. Furthermore, although that the manner in which the first impact generating device 24 and the second impact generating device 26 are connected to the impact platform 22 is not depicted in this embodiment, the first impact generating device 24 and the second impact generating device 26 may be detachably screwed or detachably buckled onto the undersurface of the impact platform 22 as can be practiced by those of ordinary skill in the art; however, the present invention is not limited thereto. Furthermore, the impact assembly 2 may further have a detecting device (not shown) such as an accelerometer. The detecting device may be disposed on the impact platform 22, but is not limited to detect and monitor the operation of the impact platform 22 for purpose of data analysis or immediately adjusting the operations of the first impact generating unit 244 and the second impact generating unit 264.

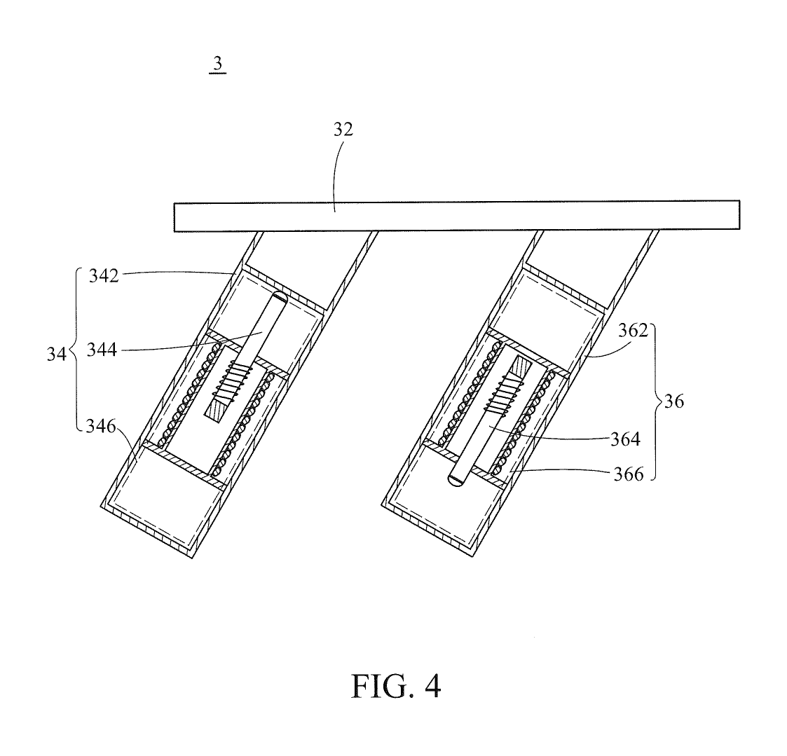

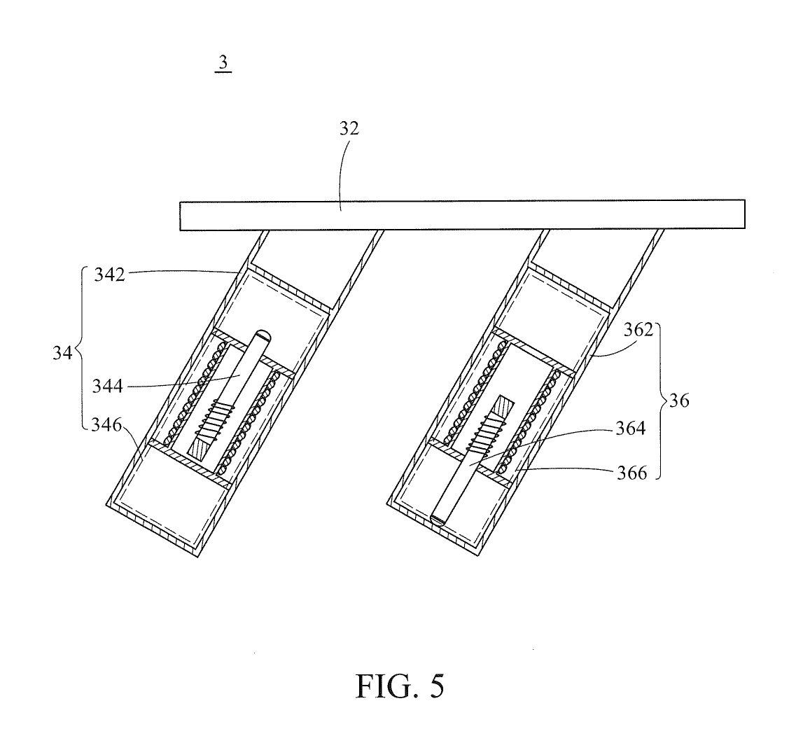

Next, FIGS. 4 and 5 illustrate the second embodiment of the present invention. As shown, similar to the first embodiment, an impact assembly 3 comprises an impact platform 32, a first impact generating device 34 and a second impact generating device 36. The first impact generating device 34 and the second impact generating device 36 are disposed adjacent to each other in pair and detachably mounted to the impact platform 32. Furthermore, the first impact generating device 34 has a first housing 342, a first impact generating unit 344 and a first compartment 346, while the second impact generating device 36 has a second housing 362, a second impact generating unit 364 and a second compartment 366. The first compartment 346 of the first housing 342 and the second compartment 366 of the second housing 362 are adapted to accommodate the first impact generating unit 344 and the second impact generating unit 364 respectively, and the first impact generating unit 344 and the second impact generating unit 364 are adapted to provide a reciprocating motion according to the first timing T1 and the second timing T2 shown in FIG. 6 respectively.

The crucial difference between the first embodiment and the second embodiment is that the first impact force provided by the first impact generating unit 344 and the second impact force provided by the second impact generating unit 364 have the exact magnitude but opposite directions. In other words, as shown in FIG. 4 and FIG. 5, if the first impact force provided by the first impact generating unit 344 impacts the impact platform 32 upwards, then the second impact force provided by the second impact generating unit 364 impacts the impact platform 32 downwards.

Therefore, in practice, the impact platform 32 of the second embodiment, unlike the impact platform 22 of the first embodiment, can be impacted again without the need of returning to the initial position after the first impact generating unit 344 of the first impact generating device 34 has impacted the impact platform 32. That is, the second impact force can be applied by the second impact generating unit 364 of the second impact generating device 36 when the impact platform 32 reaches the maximum amplitude in the upwards direction. As compared to the first embodiment, this configuration can shorten the interval between the two consecutive impacts more significantly to reduce the total testing time.

Although the attached drawings of the present invention only illustrate the examples in which an impact platform is used in combination with two impact generating devices, it shall be particularly noted that two or more pairs of impact generating devices may also be mounted onto the impact platform by those of ordinary skill in the art as needed. For example, eight impact generating devices may be disposed in pair under an impact platform to provide four groups of impact forces with different directions (angles) to the impact platform simultaneously. Of course, by adjusting the order of the timings, the impact generating devices may also be designed to provide four groups of impact forces to impact the impact platform sequentially.

According to the above descriptions, by means of the impact generating devices disposed in pair, the impact assembly of the present invention can apply an impact force to the impact platform according to the corresponding consecutive timings so that an external force that may be experienced by an object under testing can be precisely simulated. Furthermore, by disposing the impact generating devices in a pair in with consecutive timings, the delay time that would be needed for the single impact generating device which has impacted the impact platform once to restore its original impacting status in the prior art can be overcome. Thereby, the overall testing time is shortened and an impact assembly providing a periodic and consistent impact force is obtained.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An impact assembly comprising:
an impact platform; and
at least two impact generating devices, disposed adjacent to each other in pair and detachably mounted to the impact platform, wherein each of the at least two impact generating devices comprises:
a housing, comprising a compartment formed therein; and
an impact generating unit, disposed in the compartment and adapted to provide a reciprocating motion;
wherein the impact generating units of the at least two impact generating devices respectively provide at least two impact forces to the impact platform by sequentially providing the reciprocating motion according to at least two corresponding timings.

2. The impact assembly as claimed in claim 1, wherein the at least two impact generating devices comprise a first impact generating device and a second impact generating device, the at least two timings comprise a first timing and a second timing, a first impact generating unit of the first impact generating device provides a first impact force to the impact platform according to the first timing, and a second impact generating unit of the second impact generating device provides a second impact force to the impact platform according to the second timing.

3. The impact assembly as claimed in claim 2, wherein the first impact generating device comprises a first housing with a first compartment formed therein, and the second impact generating device comprises a second housing with a second compartment formed therein.

4. The impact assembly as claimed in claim 3, wherein the directions of the first impact force and the second impact force are the same.

5. The impact assembly as claimed in claim 3, wherein the direction of the first impact force is opposite to the direction of the second impact force.

6. The impact assembly as claimed in claim 3, wherein the magnitudes of the first impact force and the second impact force are the same.

7. The impact assembly as claimed in claim 1, wherein the at least two impact generating devices are electric impact generators.

8. The impact assembly as claimed in claim 1, wherein the impact generating units are micro vibration motors.

9. The impact assembly as claimed in claim 1, further comprising a detecting device disposed on the impact platform for detecting the reciprocating motion of the impact platform.

10. The impact assembly as claimed in claim 9, wherein the detecting device is an accelerometer.

11. The impact assembly as claimed in claim 1, wherein the at least two impact generating devices are detachably screwed onto the impact platform.

12. The impact assembly as claimed in claim 1, wherein the at least two impact generating devices are detachably buckled onto the impact platform.
